(19) United States
(12) Patent Application Publication
(10) Pub. No.: US 2013/0063957 A1
(43) Pub. Date: Mar. 14, 2013

(54) LIGHTING DEVICE AND MANUFACTURING METHOD THEREOF

(71) Applicants: Makoto SAKAI, Kanagawa-ken (JP); Takumi Suwa, Kanagawa-ken (JP); Shinji Nakata, Kanagawa-ken (JP); Daigo Suzuki, Kanagawa-ken (JP); Izuru Komatsu, Kanagawa-ken (JP); Michinobu Inoue, Kanagawa-ken (JP); Kumiko Ioka, Chiba-ken (JP); Kazuki Tateyama, Kanagawa-ken (JP); Yasuhide Okada, Kanagawa-ken (JP)

(72) Inventors: Makoto SAKAI, Kanagawa-ken (JP); Takumi Suwa, Kanagawa-ken (JP); Shinji Nakata, Kanagawa-ken (JP); Daigo Suzuki, Kanagawa-ken (JP); Izuru Komatsu, Kanagawa-ken (JP); Michinobu Inoue, Kanagawa-ken (JP); Kumiko Ioka, Chiba-ken (JP); Kazuki Tateyama, Kanagawa-ken (JP); Yasuhide Okada, Kanagawa-ken (JP)

(73) Assignees: Kabushiki Kaisha Toshiba, Tokyo (JP); Toshiba Lighting & Technology Corporation, Kanagawa (JP)

(21) Appl. No.: 13/601,217

(22) Filed: Aug. 31, 2012

(30) Foreign Application Priority Data
Sep. 9, 2011 (JP) 2011-197724

(51) Int. Cl. F21V 21/00; F21V 17/00

(52) U.S. Cl. 362/363; 29/592.1

(57) ABSTRACT

A lighting device according to an embodiment includes a main body unit, a light source which is provided at one end portion of the main body unit, and includes a light emitting element, a globe which is provided so as to cover the light source, and a heat conducting unit whose end surface on the globe side is exposed on the outside of the globe, and which thermally bonds the globe and a heat radiating surface of the main body unit on the end portion side. The heat conducting unit includes a plate-shaped unit in which a first plate-shaped body, and a second plate-shaped body which crosses the first plate-shaped body are integrally formed.

### CROSS-REFERENCE TO RELATED APPLICATIONS

This application is based upon and claims the benefit of priority from the prior Japanese Patent Application No. 2011-197724, filed on Sep. 9, 2011; the entire contents of which are incorporated herein by reference.

### FIELD

Embodiments to be described below generally relate to a lighting device, and a manufacturing method thereof.

### BACKGROUND

In recent years, a lighting device in which a light emitting diode (LED) is used as a light source is put into practical use instead of an incandescent light bulb (filament electric bulb).

Since the lighting device using the light emitting diode has a long life, and is able to reduce power consumption it is expected to replace the existing incandescent light bulb.

In such a lighting device using a light emitting diode, a structure is proposed in which heat generated in a light source is radiated to the outside through a main body unit.

### DESCRIPTION OF THE DRAWINGS

FIG. 1 is a schematic perspective view which exemplifies a lighting device according to a first embodiment.

FIG. 2A is a schematic diagram which exemplifies a relationship between a shape of a globe and a light distribution angle when the shape of the globe is a hemisphere.

FIG. 2B is a schematic diagram which exemplifies the relationship between the shape of the globe and the light distribution angle when the shape of the globe is approximately spherical.

FIGS. 3A to 3D are schematically, and partially enlarged views which exemplify step portions which are provided at steps of a heat conducting unit.

FIG. 4 is a graph which exemplifies the reflectance of a reflecting layer.

FIG. 5 is a schematic plan view which exemplifies a connection between a groove portion and a protruding portion for a connection.

FIG. 6A is a schematic perspective view which exemplifies a plate-shaped unit in which two plate-shaped bodies are integrated.

FIG. 6B is a schematic perspective view which exemplifies a plate-shaped unit.

FIG. 7 is a schematic plan, view which exemplifies a connection between a groove portion and a protrusion portion for connection.

FIG. 8A is a schematic view which exemplifies an opening portion which is provided at the heat conducting unit.

FIG. 8B is a schematic graph which exemplifies an effect of providing the opening portion at the heat conducting unit.

FIG. 9 is a schematic and partial cross-sectional view which exemplifies an opening portion according to another embodiment.

FIG. 10 is a schematic graph which shows an example relating to the thickness of a plate-shaped body.

FIGS. 11A and 11C are schematic diagrams which exemplify connection portions between the heat conducting unit and a substrate when reduction of thermal resistance is not considered.

FIGS. 11B and 11D are schematic diagrams which exemplify connection portions between the heat conducting unit and the substrate when reduction of thermal resistance is considered.

FIG. 12A is a schematic view which exemplifies a case where one protrusion unit is provided on the surface of the heat conducting unit.

FIG. 12B is a schematic view which exemplifies a case where a plurality of protrusion units is provided on the surface of the heat conducting unit.

FIG. 13A is a schematic view which exemplifies an arrangement of the heat conducting unit and a light emitting element when viewed in a planar manner.

FIG. 13B is a schematic view which exemplifies a positional relationship between the heat conducting unit and the light emitting element when viewed in a planar manner.

FIG. 14 is a schematic perspective view which exemplifies a globe divided into each region which is divided by the heat conducting unit.

FIG. 15A is a schematic perspective view which exemplifies a shielding unit.

FIG. 15B is a schematic perspective view which exemplifies an apex portion of the heat conducting unit.

FIG. 16A is a schematic view which exemplifies the temperature distribution of the lighting device in a lighting device in which the heat conducting unit is not provided.

FIG. 16B is a schematic view which exemplifies the temperature distribution in the vicinity of the end portion of a main body unit in the lighting device in which the heat conducting unit is not provided.

FIG. 17A is a schematic view which exemplifies a heat radiation state when the inner face of the globe and the end surface of the heat conducting unit come into contact with each other (when the end surface of the heat conducting unit is not exposed on the surface of the globe) in the lighting device in which the heat conducting unit is provided.

FIG. 17B is a schematic view which exemplifies a heat radiation state when the end surface of the heat conducting unit is exposed from the globe in the lighting device in which the heat conducting unit is provided.

FIG. 18 is a flowchart which exemplifies a manufacturing method of a lighting device according to a second embodiment.

FIGS. 19A to 19D are process drawings which exemplify a manufacturing method of the lighting device according to the second embodiment.

### DETAILED DESCRIPTION

A lighting device according to an embodiment includes, a main body unit; a light source which is provided at one end portion of the main body unit, and includes a light emitting element; a globe which is provided so as to cover the light source; a heat conducting unit whose one end surface on the globe side is exposed on the outside of the globe, and which thermally bonds the globe and a heat radiating surface on an end portion side of the main body unit. In addition, the heat conducting unit includes a plate-shaped unit in which a first plate-shaped body and a second plate-shaped body which intersects the first plate-shaped body are integrally formed.

A lighting device according to another embodiment includes, a main body unit; a light source which is provided at one end portion of the main body unit, and includes a light emitting element; a globe which is provided so as to cover the light source; a heat conducting unit whose one end surface on the globe side is exposed on the outside of the globe, and which thermally bonds the globe and a heat radiating surface on an end portion side of the main body unit. The heat conducting unit includes a third plate-shaped body, and a fourth plate-shaped body which is connected to the third plate-shaped body, and the third plate-shaped body includes a first groove portion, or a first protrusion portion at a portion connected with the fourth plate-shaped body. The fourth plate-shaped body includes a second protrusion portion which is fitted into the first groove portion, or a second groove portion which is fitted into the first protrusion portion.

A manufacturing method of a lighting device according to another embodiment includes, assembling a substrate to which a light source is provided onto one end portion of a main body unit; assembling a plate-shaped unit in which a first plate-shaped body, and a second plate-shaped body which intersects the first plate-shaped body are integrally formed onto the substrate; forming a heat conducting unit by connecting a fifth plate-shaped body to the plate-shaped unit, and by assembling the fifth plate-shaped body onto the substrate; and forming a globe by assembling the globe divided into each region which is divided by the heat conducting unit.

Hereinafter, embodiments will be exemplified with reference to the drawings. In addition, in each drawing, the same constituent elements are given the same reference numerals, and detailed descriptions thereof will be appropriately omitted.

### First Embodiment

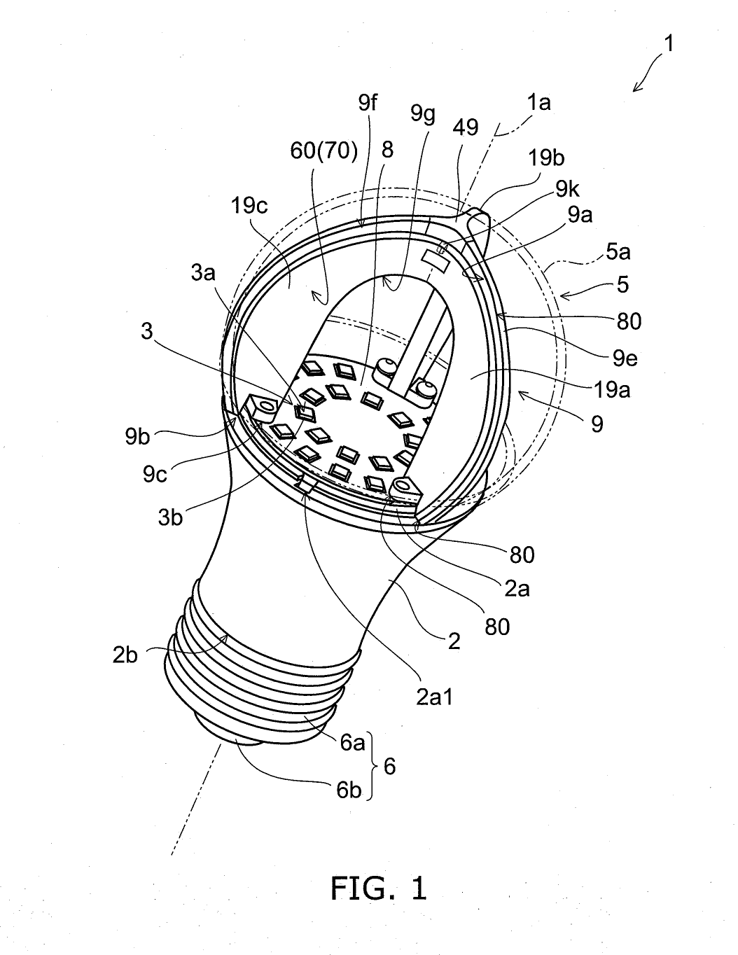

FIG. 1 is a schematic perspective view which exemplifies a lighting device according to a first embodiment.

As shown in FIG. 1, a main body unit 2, a light source 3, a globe 5, a base unit 6, a substrate 8, and a heat conducting unit 9 are provided in a lighting device 1.

The main body unit 2 may have, for example, a shape in which a cross-sectional area in a direction perpendicular to the axis direction is gradually increased toward the globe 5 side from the base unit 6. However, the shape is not limited to this, and may be appropriately changed according to, for example, the size of the light source 3, the globe 5, the base unit 6, or the like. In this case, the lighting device can be easily substituted to an existing incandescent light bulb when it is made to be approximately the same shape of a neck portion of the incandescent light bulb.

The main body unit 2 can be formed, for example, of a material having high heat conductivity. The main body unit 2 can be formed of, for example, metal such as aluminum (Al), copper (Cu), or an alloy of these. However, the material is not limited to these, and can be formed of an inorganic material such as aluminum nitride (AlN), alumina (Al₂O₃), and an organic material such as high heat conductivity resin.

The light source 3 is provided on the substrate 8 which is provided at one end portion 2a of the main body unit 2. An irradiation surface 3a of the light source 3 is provided so as to become perpendicular to a central axis 1a of the lighting device 1, and radiates light toward the axis direction of the lighting device 1. In addition, for example, it is also possible to provide a pyramid-shaped convex portion, which is not shown, at the end portion 2a and the light source 3 is provided at a slope of the convex portion. By doing so, it is possible to expand the light distribution angle, since an optical axis of the light source 3 crosses the central axis la of the lighting device 1.

The light source 3 can have light emitting elements 3b. The number of light emitting elements 3b to be provided at the light source 3 is not limited, and one or more of the light emitting elements 3b can be provided according to use of the lighting device 1, and the size of the light source 3.

The light emitting element 3b can be formed of, for example, a so-called own light emitting element such as a light emitting diode, an organic light emitting diode, or a laser diode. When a plurality of light emitting diodes 3b is provided at the light source 3, it may have a regular arranging form such as a matrix shape, a zigzag shape, or a radial pattern, or may have an arbitrary arranging form.

In addition, the number, the arrangement, or the like of the light source 3 may be appropriately changed.

The globe 5 is provided at the end portion 2a of the main body unit 2 so as to cover the light source 3. The globe 5 can have a curved surface which protrudes in the irradiation direction of light.

The globe 5 is divided into each region which is divided by the heat conducting unit 9, and an end surface 9e of the heat conducting unit 9 is exposed on the outside of the globe 5.

The globe 5 is translucent, and light which is radiated from the light source 3 can be output to the outside of the lighting device 1. The globe 5 can be formed of a translucent material, and for example, can be formed of glass, transparent resin such as polycarbonate, translucent ceramics, or the like. In addition, it is possible to apply a dispersing agent, a fluorescent substance, or the like in the inner surface of the globe 5, or to make the globe 5 include the dispersing agent, the fluorescent substance, or the like therein (dispersing agent, or fluorescent substance is kneaded into the translucent material) as necessary.

The base unit 6 is provided at an end portion 2b which is on the opposite side to the side of the main body unit 2 where the globe 5 is provided. The base unit 6 can have a shape which can be attached to a socket to where an incandescent light bulb is attached. The base unit 6 can have the same shape as the Japanese Industrial Standards E26, or E17. However, the shape of the base unit 6 can be appropriately changed without being limited to the exemplified shapes. For example, the base unit 6 can have a pin-shaped terminal which is used in a fluorescent lamp, or can have an L-shaped terminal which is used in a hooking ceiling.

The base unit 6 which is shown in FIG. 1 includes a cylinder-shaped shell unit 6a with a thread ridge, and an eyelet unit 6b which is provided at an end portion opposite to the portion where the shell unit 6a is provided at the main body unit 2. A control unit (not shown) is electrically connected to the shell unit 6a, and the eyelet unit 6b.

The control unit which is not shown is provided in the main body unit 2. The control unit can have a lighting circuit which supplies power to the light source 3. In addition, the control unit can have a dimming circuit which performs dimming of the light source 3, as well.

The substrate 8 is provided at one end portion 2a of the main body unit 2.

The substrate 8 can be formed of, for example, a material with high thermal conductivity. The substrate 8 is formed of, for example, metal such as aluminum (Al), copper (Cu), iron (Fe), and an alloy of these, and can be formed with a wiring pattern (not shown) through an insulating layer on the surface thereof. In addition, the material of the substrate 8 is not limited to the examples, and can be appropriately changed. For example, the substrate 8 can be formed with the wiring pattern on the surface of a base material to which resin is used. For the substrate 8, it is possible to use the base material which is formed of the inorganic material such as aluminum nitride (AlN), or the organic material such as resin with high heat conductivity. However, when the substrate 8 is formed of the material with high heat conductivity, heat generated in the light source 3 can be easily radiated to the outside through the substrate 8, and the main body unit 2. In addition, as described later, the heat generated in the light source 3 can be easily radiated to the outside through the substrate 8, the heat conducting unit 9, and the globe 5. In addition, the radiation of heat through the substrate 8, the heat conducting unit 9, and the globe 5 will be described in detail later.

Here, the heat generated in the light source 3 is radiated to the outside through the substrate 8, and the main body unit 2. However, when the power supplied to the light source 3 is increased, or the like, in order to produce higher luminance flux of the lighting device 1, there is a concern that a sufficient cooling effect may not be obtained by the heat radiation from the main body unit 2 alone.

In addition, when the light emitting element 3b is used in the light source 3, there is a problem in that the light distribution angle becomes narrow compared to the incandescent light bulb. In this case, it is possible to expand the light distribution angle when the shape of the globe 5 becomes approximately spherical. However, as described later, when the shape of the globe 5 becomes approximately spherical, there is a concern that the sufficient cooling effect may not be obtained only by the heat radiation from the main body unit 2, since the size of the main body unit 2 becomes small.

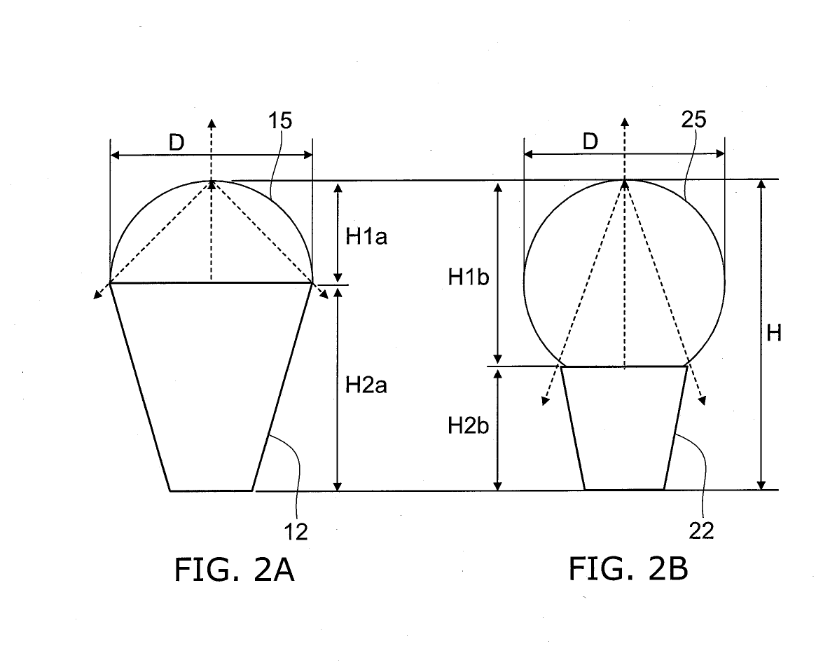

FIG. 2 is a schematic view which exemplifies a relationship between the shape of the globe and the light distribution angle.

In addition, FIG. 2A shows a case where a shape of a globe 15 is a hemisphere, and FIG. 2B shows a case where a shape of a globe 25 is approximately spherical.

In addition, arrows in the figure denote the proceeding direction of light. In this case, to avoid complicated descriptions, necessary descriptions for the light distribution angle are representatively described.

Here, when considering substituting with the existing incandescent light bulb, it is preferable to make the external dimensions of the lighting device 1 approximately the same as those of the incandescent light bulb. For this reason, in FIGS. 2A and 2B, the diameters of the globes 15 and 25 are set to D, the height of the lighting device is set to H, and these are set to approximately the same dimension as those of the units of the incandescent light bulb.

As shown in FIG. 2B, when the shape of the globe 25 becomes approximately spherical, it is possible to radiate light further to the rear side compared to the case of the hemispherical globe 15 shown in FIG. 2A. For this reason, it is possible to expand the light distribution angle.

However, when the shape of the globe 25 becomes approximately spherical, the height H1b of the globe 25 becomes larger than the height H1a of the globe 15. On the other hand, since the height H of the lighting device is constant, the height H2b of a main body unit 22 becomes smaller than the height H2a of a main body unit 12. That is, when the shape of the globe 5 becomes approximately spherical in order to expand the light distribution angle, there is a concern that the heat radiation from the main body unit 2 becomes difficult, since the size of the main body unit 2 becomes small.

In this manner, when the basic performance of the lighting device such as higher luminous flux, the expansion of light distribution angle, or the like, is assumed to be improved, there is a concern that the sufficient cooling effect may not be obtained only by the heat radiation from the main body unit 2. Therefore, according to the embodiment, a heat radiation amount from the globe 5 is increased by providing the heat conducting unit 9.

The heat conducting unit 9 thermally bonds to the globe 5, and the heat radiating surface on the end portion 2a side of the main body unit 2. In this case, as shown in FIG. 1, the heat conducting unit 9 is able to include a peripheral portion 9a at least a part thereof is thermally bonds to the globe 5, an end portion 9b at least a part thereof is thermally bonds to the end portion 2a of the main body unit 2, and an end portion 9c at least a part thereof is thermally bonds to the substrate 8.

In addition, in the present specification, “thermally bonds” means that heat is conducted by at least any one of heat conduction, convex, and radiation between the heat conducting unit 9 and counterpart members thereof. For example, it is possible to conduct heat by performing heat conduction by coming into contact with the heat conducting unit 9, or using the convex, or radiation by providing a small gap between the heat conducting unit 9.

That is, the peripheral portion 9a, and the end portions 9b and 9c of the heat conducting unit 9 may come into contact with the counterpart members, or may be separated therefrom to an extent of being able to conduct the heat.

In this case, for the heat conducting, it is preferable to make the peripheral portion 9a, and the end portions 9b and 9c of the heat conducting unit 9 come into contact with the counterpart members, since it is possible to improve the heat radiating effect.

In addition, for the thermal bonding, it is possible to perform the thermal bonding at least a part of the peripheral portion 9a, and the end portions 9b and 9c, not necessarily on the entire portion thereof.

In this case, it is more preferable to perform the thermal bonding on as wide an area as possible.

In addition, at least any one of the end portion 2a of the main body unit 2, the substrate 8, and the irradiation surface 3a of the light source 3 become heat radiation surfaces on the end portion 2a side of the main body unit 2. For this reason, it is preferable that an end portion of the heat conducting unit 9, in which at least a part thereof is thermally bonded to at least any one of these heat radiation surfaces, be provided. In addition, it is possible to provide a bonding unit 80 including a material with high heat conductivity between at least a part of the end portions 9b and 9c of the heat conducting unit 9 and the heat radiating surface on the end portion 2a side.

For example, it is possible to provide the bonding unit 80 by bonding the end portion 2a of the main body unit 2 and the end portion 9b using solder or the like. In addition, for example, it is possible to provide the bonding unit 80 by bonding the substrate 8 and the end portion 9c using solder or the like.

In addition, it is possible to provide the bonding unit 80 including a material with high heat conductivity between the globe 5 and the peripheral portion 9a.

It is possible to provide the bonding unit 80 by bonding the globe 5 and the peripheral portion 9a using, for example, an adhesive with high heat conductivity to which ceramic filler with high heat conductivity, or filler metal or the like is added.

In order to thermally bond the peripheral portion, or the end portion of the heat conducting unit 9 to the counterpart, it is possible to make them simply come into contact with each other. However, since it is possible to decrease a heat resistance when the peripheral portion, or the end portion of the heat conducting unit 9, and the counterpart are bonded to each other through the bonding unit 80 including the material with high heat conductivity, it is possible to improve the cooling effect to be described later

In addition, there is a case where a gap occurs when bonding the end portion of the heat conducting unit 9 and the counterpart. Since the heat resistance is increased when the gap occurs, it is possible to decrease the heat resistance by performing the bonding through the bonding unit 80 even when the gap occurs.

The heat conducting unit 9 can be formed of a material with high heat conductivity. The heat conducting unit 9 can be formed of, for example, the metal such as aluminum (Al), copper (Cu), and the alloy of these. However, the material is not limited to these, and can be formed of an inorganic material such as aluminum nitride (AlN), and an organic material such as high heat conductivity resin.

In addition, it is possible to provide a step at the end portion on the globe 5 side of the heat conducting unit 9.

There is a case where a gap occurs due to a manufacturing error or the like between the heat conducting unit 9 and the globe 5. When the gap occurs between the heat conducting unit 9 and the globe 5, there is a concern that the light radiated from the light source 3 is leaked from the gap, or dust and ash in the outside come into the globe 5 from the gap.

For this reason, a step is provided at the end portion of the heat conducting unit 9 on the globe 5 side.

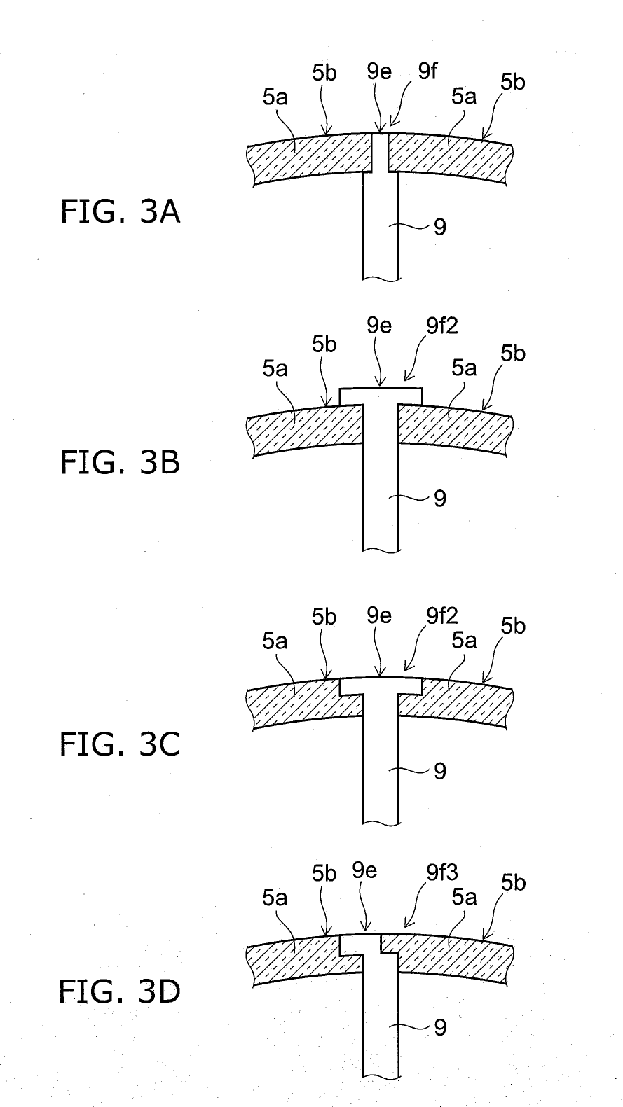

FIGS. 3A to 3D are schematically, and partially enlarged views which exemplify a step portion 9f which is provided at a step of the heat conducting unit 9.

For example, as shown in FIG. 3A, it is possible to make the step portion 9f have a concave portion which is recessed in the thickness direction (thickness direction of the plate-shaped body) of the heat conducting unit 9. It is possible to make the heat conducting unit 9 and the globe 5 overlap at the concave portion when the step portion 9f with the concave shape is provided. For this reason, it is possible to prevent the light radiated from the light source 3 from leaking from the gap, or to prevent the dust and ash in the outside from coming into the globe 5 from the gap. Further, it is possible to easily assemble the globe 5. In this case, it is preferable that an end surface 9e of the heat conducting unit 9 be flush with the outer peripheral surface 5b of the globe 5.

In addition, for example, as shown in FIGS. 3B and 3C, it is possible to make a step portion 9f2 have a convex shape protruding in the thickness direction (thickness direction of the plate-shaped body) of the heat conducting unit 9. When providing the step portion 9f2 having the concave shape, it is possible to make the heat conducting unit 9 and the globe 5 overlap with each other. For this reason, it is possible to prevent the light radiated from the light source 3 from leaking from the gap, or to prevent the dust and ash in the outside from coming into the globe 5 from the gap.

In this case, as shown in FIG. 3C, it is preferable that the end surface 9e of the heat conducting unit 9 be flush with the outer peripheral surface 5b of the globe 5.

In addition, for example, as shown in FIG. 3D, it is also possible to provide a step portion 9f3 with the convex shape and the concave shape.

That is, the heat conducting unit 9 is able to have a step portion with at least any one of the convex shape protruding to the thickness direction (thickness direction of the plate-shaped body) of the heat conducting unit 9, and the concave shape recessing to the thickness direction (thickness direction of the plate-shaped body) of the heat conducting unit 9, at the end portion on the globe 5 side.

Here, when the heat conducting unit 9 is simply provided at the inner side of the globe 5, there is a concern that luminance unevenness in the lighting device 1 may become large since a difference between a bright portion and dark portion which occurs in the globe 5 becomes large when the light radiated from the light source 3 is absorbed to the heat conducting unit 9, or the like.

For this reason, the heat conducting unit 9 is set to be able to reflect the light which is radiated from the light source 3.

In this case, for example, the heat conducting unit 9 is set to be able to have higher reflectance than the globe 5.

The heat conducting unit 9, for example, is set to be able to include a reflecting layer 60 on the surface thereof.

The reflecting layer 60, for example, can be set to a layer which is formed by being applied with white paint. In this case, it is preferable that the paint used in the white paint be paint with a resistance to heat generated in the lighting device 1, and a resistance to the light radiated from the light source 3. As such paint, for example, there are white paint of a polyester resin system which includes at least one or more of white paint of titanium oxide (TiO₂), zinc oxide (ZnO), barium sulfate (BaSO₄), magnesium oxide (MgO), or the like, white paint of acrylic resin system, white paint of epoxy resin system, white paint of silicon resin system, white paint of urethane resin system, paint in which two or more white paint selected from these are put together, or the like.

In this case, it is preferable to use the white paint of the polyester resin system, and the white paint of silicon resin system.

However, the reflecting layer 60 is not limited to these, and for example, it may be a layer in which metal such as silver with high reflectance, aluminum or the like is coated using plating, an evaporation method, sputtering method, or the like, or which is formed by being clad with a base material.

In addition, it is possible to form the heat conducting unit 9 itself Using a material with high reflectance.

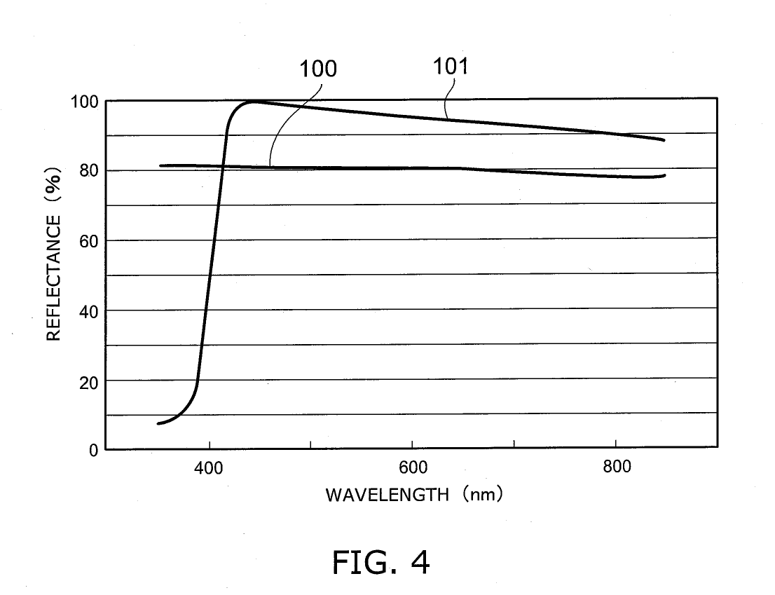

FIG. 4 is a graph which exemplifies the reflectance of the reflecting layer.

In addition, in FIG. 4, 100 denotes a case of a reflecting layer which is formed by an aluminum rolled sheet (A1050 in Japanese Industrial Standards), and 101 denotes a case of a reflecting layer which is formed by being applied with the white paint of polyester resin system.

When the reflecting layer 60 is provided, or the heat conducting unit 9 itself is formed using a material with high reflectance, it is preferable that the reflectance with respect to the light radiated from the light source 3 be 90% or more, and more preferably 95% or more In addition, in the reflectance in the application, wavelength of light is at least in the vicinity of 460 nm, or in the vicinity of 570 nm.

For this reason, it is preferable that the reflecting layer 60 be formed by applying the white paint of polyester resin system.

When the heat conducting unit 9 is able to reflect the light which is radiated from the light source 3, it is possible to decrease the luminance unevenness in the lighting device 1, since it is possible to reduce the difference between the bright portion and the dark portion which occurs in the globe 5. In addition, it is also possible to expand the light distribution angle in the lighting device 1.

The heat conducting unit 9 has a form in which a plate-shaped body 19a (corresponding to an example of a first plate-shaped body), a plate-shaped body 19b (corresponding to an example of a second plate-shaped body), and a plate-shaped body 19c (corresponding to an example of a fifth plate-shaped body) are crossed at the central axis 1a of the lighting device 1.

The heat conducting unit 9 may be a unit in which the plate-shaped bodies 19a, 19b, and 19c are arranged so as to be rotational symmetry with respect to the central axis la of the lighting device 1. In addition, when a plurality of light sources. 3 is provided at a position which can be approximately rotational symmetry with respect to the central axis 1a of the lighting device 1, the central axis 1a of the lighting device 1 can be an optical axis of the lighting device 1, as well.

Here, three plate-shaped bodies 19a′, 19b′, and 19c′are respectively formed, and it is possible to form the heat conducting unit 9 by assembling the formed three plate-shaped bodies 19a′, 19b′, and 19c′.

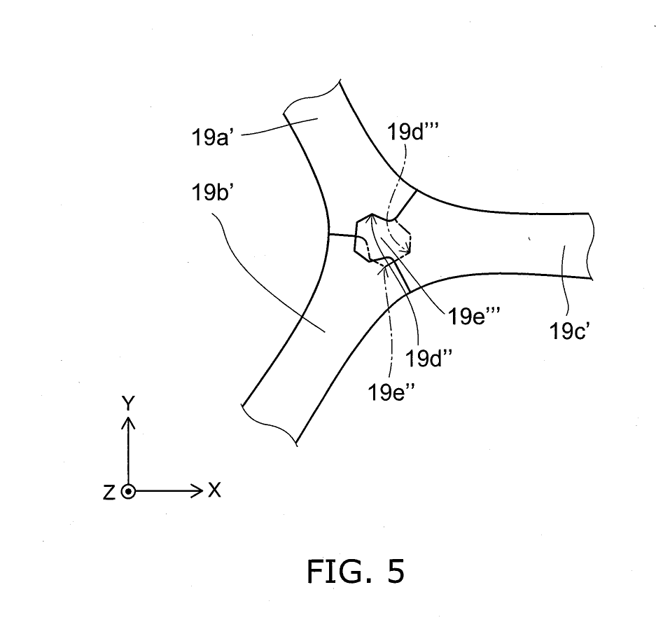

FIG. 5 is a schematically plan view which exemplifies a connection of a groove portion and a protrusion portion for connecting, In addition, arrows X, Y, and Z in FIG. 5 denote three directions which are orthogonal to each other, and for example, X and Y are directions which are parallel to the end portion 2a of the main body unit 2, and Z is a direction which is perpendicular to the end portion 2a of the main body unit 2.

As shown in FIG. 5, the heat conducting unit 9 may be a unit in which, for example, plate-shaped body 19a′ (corresponding to an example of a third plate-shaped body), and a plate-shaped body 19c′ which crosses the plate-shaped body 19a′ (corresponding to an example of a fourth plate-shaped body) are included.

In addition, the plate-shaped body 19a′ may be a unit which includes a first groove portion 19d″, or a first protrusion portion 19e″ at a portion at which being connected to the plate-shaped body 19c′. The plate-shaped body 19c′ may be a unit which includes a second protrusion portion 19e′″ which is fitted into the first groove portion 19d′, or a second groove portion 19d″ which is fitted into the first protrusion portion 19e″. In this manner, it is possible to easily perform the assembling with good precision when assembling a plurality of plate-shaped bodies using the groove portion and protrusion portion. In addition, detailed descriptions relating to the assembling using the groove portion and protrusion portion will be described later.

However, when assembling the three plate-shaped bodies 19a, 19b, and 19c one by one, there is a case where it is difficult to perform a suitable positioning. For this reason, there is a concern that the number of assembling processes may be increased, or assembling precision may become worse.

Therefore, in the example shown in FIG. 1, suitable positioning can be easily performed when assembling using a plate-shaped unit in which two plate-shaped bodies are integrally formed.

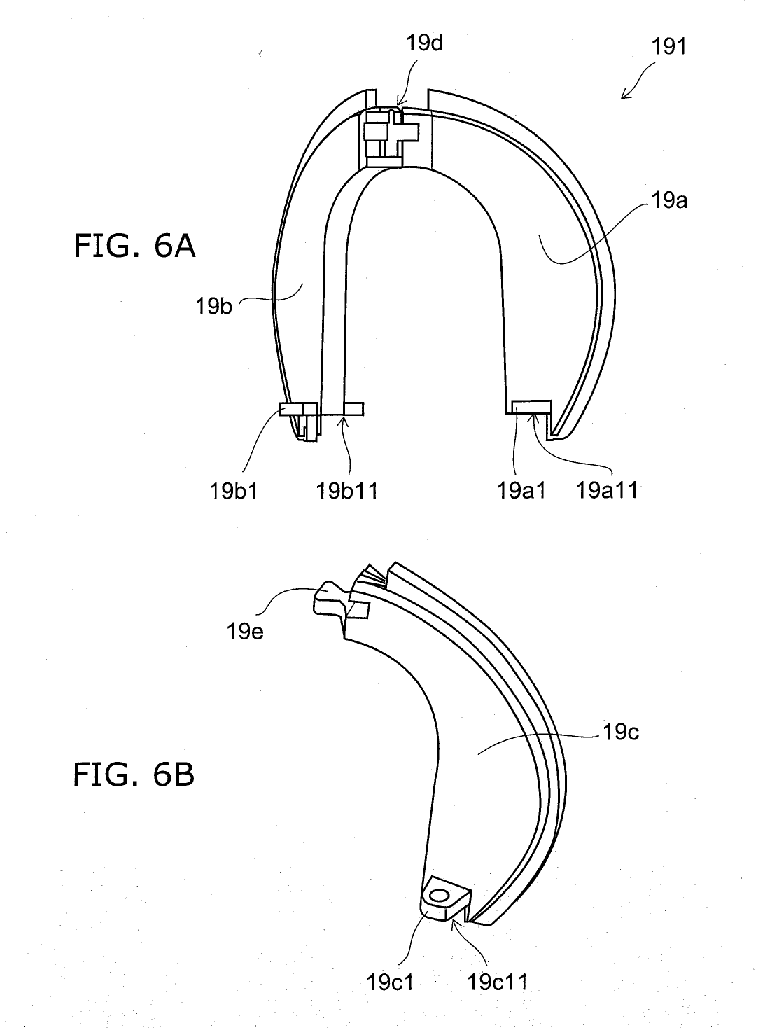

FIGS. 6A and 6B are schematic perspective views which exemplify a plate-shaped body configuring the heat conducting unit 9. In addition, FIG. 6A is a schematic perspective view which exemplifies a plate-shaped unit 191 in which two plate-shaped bodies 19a and 19b are integrally formed, and FIG. 6B is a schematic perspective view which exemplifies the plate-shaped body 19c.

As shown in FIG. 6A, when providing the plate-shaped unit 191 in which the plate-shaped bodies 19a and 19b which crosses the plate-shaped body 19c are integrally formed, the positioning of the plate-shaped bodies 19a and 19b is performed at the stage of configuring the members. In addition, when the plate-shaped unit 191 is firstly assembled, and the plate-shaped body 19c is assembled based on the plate-shaped unit 191, then the suitable positioning of the plate-shaped bodies 19a, 19b, and 19c can be easily performed.

In this case, when the three plate-shaped bodies 19a, 19b, and 19c are integrally formed, it is difficult to make attaching surfaces 19a11, 19b11, and 19c11 of attaching portions 19a1, 19b1, and 19c1 which are respectively provided at the plate-shaped bodies 19a, 19b, and 19c be flush with each other . That is, when the three plate-shaped bodies 19a, 19b, and 19c are integrally formed, there is a concern that a wobble may occur when assembling the heat conducting unit 9, or the heat conducting unit 9 may be assembled by being slanted. In this case, the attaching surfaces 19a11, 19b11, and 19c11 correspond to the above described end portion 9c of the heat conducting unit 9. In addition, when a gap occurs between the plate-shaped bodies 19a, 19b, and 19c and the substrate 8 as the heat radiating surface of the main body unit 2 on the end portion 2a side, the heat resistance is increased.

In addition, the plate-shaped unit 191 includes a groove portion 19d (corresponding to an example of a third groove portion) for connecting which is extended in the direction of central axis 1a of the lighting device 1 at the portion at which being connected to the plate-shaped body 19c. The plate-shaped body 19c includes a protrusion 19e (corresponding to an example of a fourth protrusion) to be fitted into the groove portion 19d. In addition, the plate-shaped unit 191 may include a protrusion unit (corresponding to an example of a third protrusion), and the plate-shaped body 19c may include a groove portion for connecting which extends (corresponding to an example of a fourth groove) in the direction of central axis 1a of the lighting device 1.

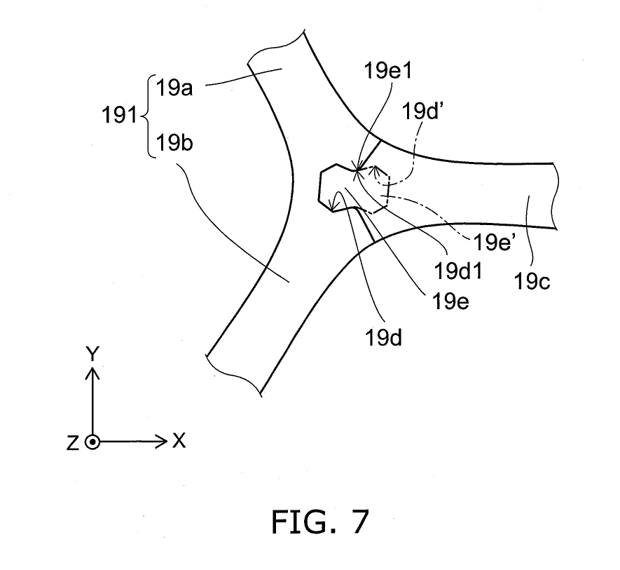

FIG. 7 is a schematic plan view which exemplifies a connection between the groove portion and the protrusion portion for connecting. In addition, arrows X, Y, and Z in FIG. 7 denote three directions which are orthogonal to each other, and for example, X and Y are directions which are parallel to the end portion 2a of the main body unit 2, and Z is a direction which is perpendicular to the end portion 2a of the main body unit 2.

As shown in FIG. 7, first, the plate-shaped unit 191 is assembled, and the plate-shaped body 19c is assembled in the Z direction so as to fit the protrusion 19e into the groove portion 19d. By fitting the protrusion 19e into the groove portion 19d, it is possible to easily perform the suitable positioning of the plate-shaped body 19c in the Z direction and Y direction. In addition, since the plate-shaped body 19c is assembled in the Z direction, it is possible to prevent a gap from occurring between the plate-shaped body 19c and the heat radiating surface of the main body unit 2 on the end portion 2a side. For this reason, it is possible to prevent the heat resistance between the heat conducting unit 9 and the heat radiating surface of the main body unit 2 on the end portion 2a side from increasing.

In addition, a convex portion 19d1 is provided at the opening side of the groove portion 19d. A concave portion 19e1 is provided at a position corresponding to the convex portion 19d1 of the protrusion portion 19e. In addition, it is possible to easily perform suitable positioning of the plate-shaped body 19c in the X direction by fitting the convex portion 19d1 into the concave portion 19e1.

As above, a case where the heat conducting unit 9 is configured using three plate-shaped bodies is described, however, a case where heat conducting unit 9 is configured using two plate-shaped bodies, or four plate-shaped bodies can be treated similarly. For example, when the heat conducting unit 9 is configured using four plate-shaped bodies, first, the plate-shaped unit 191 in which two plate-shaped bodies are integrally formed is assembled, and then the plate-shaped body may be assembled to the plate-shaped unit one by one. In addition, it is also possible to assemble one plate-shaped unit 191, and assemble another plate-shaped unit 191 to this.

In addition, it is also possible to provide the protrusion portion 19e′ at the plate-shaped unit 191, and provide the groove portion 19d′ at the plate-shaped body 19c.

As shown in FIG. 1, an opening portion 9g is provided at the heat conducting unit 9.

As in the example in FIG. 1, when the light source 3 is provided at the end portion 2a of the main body unit 2, the heat conducting unit 9 is provided at a position at which light which is radiated from the light source 3 is shielded.

For this reason, there is a concern that light extraction efficiency may decrease since the light radiated from the light source 3 is shielded in the heat conducting unit 9.

According to the embodiment, by providing the opening portion 9g in the heat conducting unit 9, the light radiated from the light source 3 is prevented from being shielded.

The plate-shaped bodies which configure the heat conducting unit 9 respectively include the opening portions 9g which penetrate the respective thickness directions.

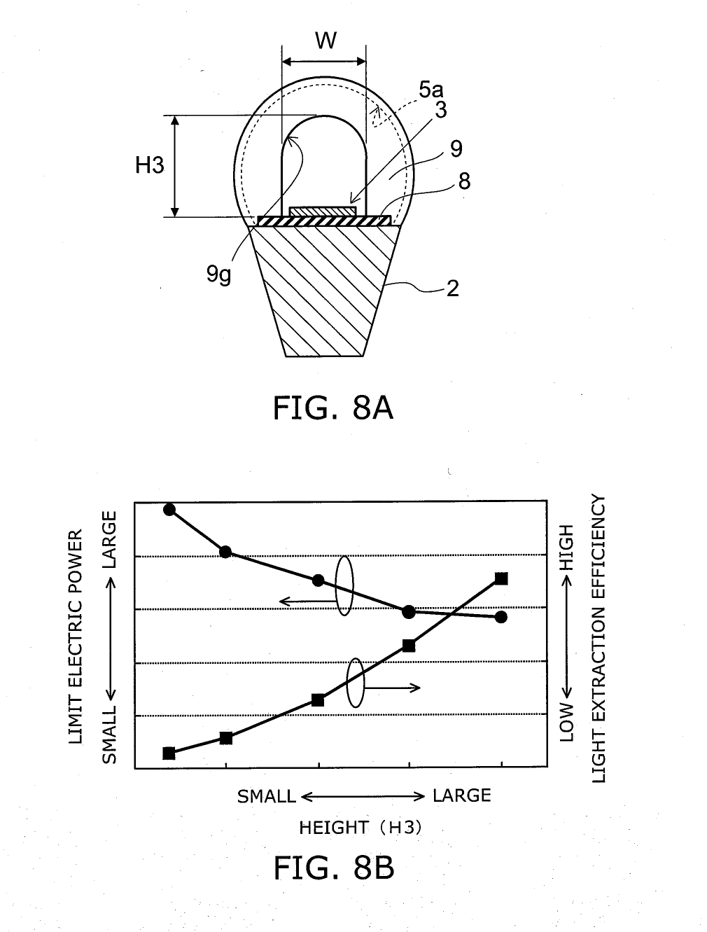

FIGS. 8A and 8B are schematic diagrams which exemplify the opening portion 9g which is provided in the heat conducting unit 9.

In addition, FIG. 8A is a schematic diagram which exemplifies the opening portion 9g which is provided at the heat conducting unit 9, and FIG. 8B is a schematic graph which exemplifies an effect of providing the opening portion 9g.

As shown in FIG. 8A, the opening portion 9g whose height is H3 is provided at the heat conducting unit 9. As described above, when the opening 9g is provided, it is possible to prevent the light radiated from the light source 3 from being shielded.

For example, as shown in FIG. 8B, it is possible to improve the light extraction efficiency when the height H3 of the opening portion 9g is increased. In addition, in FIG. 8B, a case where the height H3 of the opening portion 9g is changed is exemplified, however, it is the same as the case where the width W of the opening portion 9g is changed. That is, it is also possible to improve the light extraction efficiency when increasing the width W of the opening portion 9g.

However, when an excessively large opening portion 9g is provided, there is a concern that a light amount which is radiated from the light source 3 may be reduced, since an amount of heat conductivity, and a heat radiation amount by the heat conducting unit 9 are reduced. For example, as shown in FIG. 8B, when the height H3 of the opening portion 9g is increased, a limit electric power (electric power which can be input to the light emitting element 3b) becomes small since the heat radiation amount by the heat conducting unit 9 becomes small. In addition, when the limit electric power becomes small, the light amount radiated from the light source 3 is decreased.

For this reason, it is possible to appropriately determine the size of the opening 9g in consideration of properties of the light emitting element 3b, the improvement of light extraction efficiency due to the provision of the opening portion 9g, and the decrease in the heat radiation due to the provision of the opening portion 9g.

In addition, in FIG. 8A, the opening portion 9g which opens at the peripheral edge of the heat conducting unit 9 on the main body unit 2 side is exemplified, however, the shape, or the position of the opening portion 9g to be provided may be appropriately changed.

However, it is possible to improve the light extraction efficiency by providing the opening portion 9g at a position which is closer to the light source 3. For this reason, it is preferable to provide the opening portion 9g which opens to the peripheral edge of the heat conducting unit 9 on the main body unit 2 side which is exemplified in FIG. 8A.

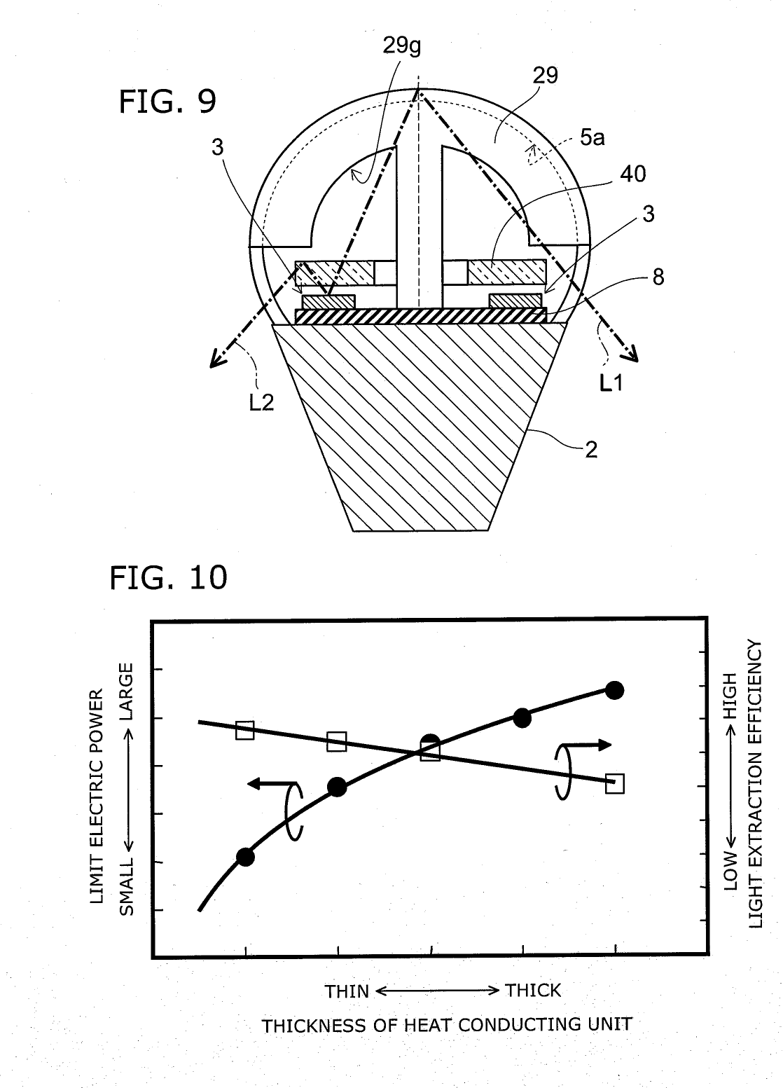

FIG. 9 is a schematically and partially cross-sectional view which exemplifies an opening portion according to another embodiment.

As shown in FIG. 9, an opening portion 29g which is provided at a heat conducting unit 29, opens to an end portion of the heat conducting unit 29 on the main body unit 2 side, and an end portion on the globe 5 side. The heat conducting unit 29 is extended to the globe 5 by coming into contact with the substrate 8, in the central site, and is extended to the outside from the axis of the lighting device along the globe shape in the vicinity of the globe 5. A cross-sectional shape including the axis of the lighting device of the heat conducting unit 29 is an “umbrella shape”.

Here, a state where a part of the light output from the light source 3 is propagated in the globe 5, and is reflected is denoted by dashed lines (light L1 and L2) by projecting to the cross section in FIG. 9.

In this case, when an opening portion 29g which opens to the peripheral edge of the heat conducting unit 29 on the globe 5 side is provided, and as shown in FIG. 9, the light L1 which is output from the light source 3, and is reflected in the inner surface of the globe, and light L2 which is reflected on an end surface of a lens 40 are radiated to the rear surface direction of the lighting device. For this reason, it is possible to improve the light extraction efficiency, and to expand the light distribution angle.

In the heat conducting unit 29, a plate-shaped body of left half, and a plate-shaped body of right half in FIG. 9 are integrally formed. The two plate-shaped bodies are connected at a position, for example, which is denoted by the dotted line in FIG. 9.

Alternately, in the heat conducting unit 29, the plate-shaped body of left half, and the plate-shaped body of right half in FIG. 9 can be separately configured, and can be connected at a portion of the dotted line in FIG. 9.

It is possible to further add a separate plate-shaped body (not shown) to the heat conducting unit 29. The added plate-shaped body configures a part of the heat conducting unit 29 by crossing another plate-shaped body, or by being connected in the dotted line portion shown in FIG. 9.

In addition, it is possible to arrange the light source 3 in a circle. It is also possible to provide the light source 3 in the vicinity of the globe 5.

In addition, as shown in FIG. 9 it becomes easy to provide an optical element such as a toric lens 40.

In this case, the position at which the opening portion 29g opens at the peripheral edge of the heat conducting unit 29 on the globe 5 side is not particularly limited.

However, as shown in FIG. 9, when the opening portion 29g opens at a position which is closer to the main body unit 2, it is possible to improve the light extraction efficiency, and to further expand the light distribution angle.

As exemplified above, it is possible to make the opening portion open at least any one of the peripheral edge of the heat conducting unit on the main body unit side, or the peripheral edge of the heat conducting unit on the globe 5 side.

FIG. 10 is a schematic graph which shows an example relating to the thickness of the plate-shaped body.

As shown in FIG. 10, the thicker the thickness of the plate-shaped body, the lower the light extraction efficiency. On the other hand, the thicker the thickness of the plate-shaped body, the higher the heat radiation amount due to the heat conducting unit 9, accordingly, the limit electric power becomes large. In addition, when the limit electric power becomes large, it is possible to increase the light amount which is radiated from the light source 3.

In addition, as described above, when considering substituting to the existing incandescent light bulb, it is preferable to make the external dimension of the lighting device 1 be the same as that of the incandescent light bulb, if possible. For this reason, since the area of a region where the light source 3 and the heat conducting unit 9 are arranged is limited, there is a concern that the number of light emitting elements 3b may be decreased when the thickness of the plate-shaped body becomes excessively large. In addition, there is a concern that the light extraction efficiency may be decreased when the thickness of the plate-shaped body becomes excessively large.

In addition, when the thickness of the plate-shaped body becomes excessively small, there is a concern that manufacturing of the heat conducting unit 9 may become difficult.

For this reason, it is preferable that the thickness of the plate-shaped body be determined considering the heat radiation amount by the heat conducting unit 9, the area of the region where the light source 3 and the heat conducting unit 9 are arranged, and manufacturing of the heat conducting unit 9.

According to the knowledge the inventors got, it is possible to determine the thickness of the plate-shaped body considering all of the heat radiation amount by the heat conducting unit 9, the area of the region where the light source and the heat conducting unit 9 are arranged, and the manufacturing of the heat conducting unit 9, when the thickness of the plate-shaped body is set to 0.5 mm or more, and 5 mm or less. In addition, it is possible to make the light extraction efficiency be 90% or more when the thickness of the plate-shaped body is set to 0.5 mm or more, and 5 mm or less.

Therefore, in order to increase the heat conducting amount, and the heat radiation amount in the heat conducting unit 9, it is possible to make the heat resistance low in a connection portion between the heat conducting unit 9 and elements which are provided on the main body unit 2 side.

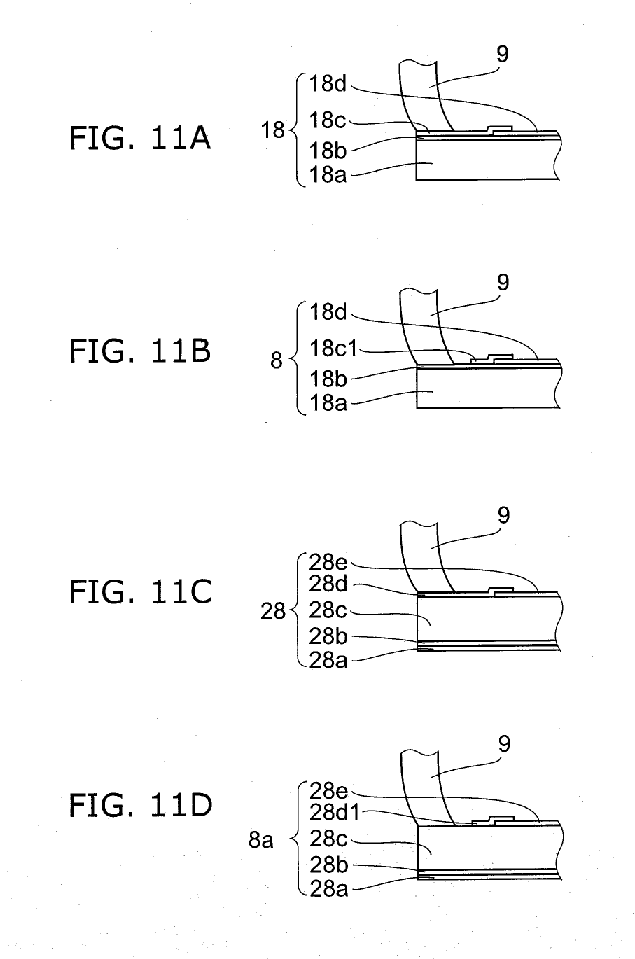

FIGS. 11A to 11D are schematic diagrams which exemplify a connection portion between the heat conducting unit and the substrate. In addition, FIGS. 11A and 11C are diagrams in which a reduction of the heat resistance is not considered, and FIGS. 11B and 11D are diagrams in which the reduction of the heat resistance is performed.

As shown in FIG. 11A, a base portion 18a which is formed of aluminum, copper, or the like, an insulating unit 18b which is provided on the base portion 18a, a solder resist unit 18c which is provided on the insulating unit 18b, and a wiring unit 18d which is provided on the insulating unit 18b are provided on a substrate 18. That is, the substrate 18 is a so-called metal base substrate.

The solder resist unit 18c can be formed by applying solder resist which is formed of resin using a print method, a photograph method, or the like.

However, since the solder resist unit 18c is formed by applying the solder resist which is formed of resin, the heat resistance at a connection portion between the heat conducting unit 9 and the substrate 18 is increased.

In contrast to this, as shown in FIG. 11B, a base portion 18a, an insulating unit 18b which is provided on the base portion 18a, a solder resist unit 18c1 which is provided on the insulating unit 18b, and a wiring unit 18d which is provided on the insulating unit 18b are provided on the substrate 8.

In this case, the heat conducting unit 9 and the insulating unit 18b are connected at the connection portion between the heat conducting unit 9 and the substrate 8 without providing the solder resist unit 18c1. For this reason, it is possible to reduce the heat resistance by an amount of the solder resist unit 18c1.

In addition, when forming the solder resist unit 18c1, it is possible to skip forming of the solder resist unit 18c1 in a region to where the heat conducting unit 9 is connected, and to form the solder resist unit 18c1 by peeling the solder resist off in the region to where the heat conducting unit 9 is connected.

As shown in FIG. 11C, a solder resist unit 28a, a wiring unit 28b which is provided on the solder resist unit 28a, an insulating unit 28c which is provided on the wiring unit 28b, a solder resist unit 28d which is provided on the insulating unit 28c, and a wiring unit 28e which is provided on the insulating unit 28c are provided on a substrate 28. That is, the substrate 28 is a so-called resin substrate.

The solder resist unit 28d can be formed by applying solder resist which is formed of resin using the print method, or the photograph method.

However, since the solder resist unit 28d is formed by using the solder resist which is formed of resin, the heat resistance at a connection portion between the heat conducting unit 9 and the substrate 28 is increased.

In contrast to this, as shown in FIG. 11D, the solder resist unit 28a, the wiring unit 28b which is provided on the solder resist unit 28a, the insulating unit 28c which is provided on the wiring unit 28b, a solder resist unit 28d1 which is provided on the insulating unit 28c, and a wiring unit 28e which is provided on the insulating unit 28c are provided on a substrate 8a.

In this case, the heat conducting unit 9 and the insulating unit 28c are connected at the connection portion between the heat conducting unit 9 and the substrate 8a without providing the solder resist unit 28d1. For this reason, it is possible to reduce the heat resistance by an amount of the solder resist unit 28d1.

In addition, when forming the solder resist unit 28d1, it is possible to skip forming of the solder resist unit 28d1 in a region to where the heat conducting unit 9 is connected, and to form the solder resist unit 28d1 by peeling the solder resist off in the region to where the heat conducting unit 9 is connected.

That is, it is possible not to provide the solder resist unit which is formed of the solder resist between the end portion 9c of the heat conducting unit 9 and the substrate 8.

As described above, it is a case where a member with high heat resistance is not provided between the end portion 9c of the heat conducting unit 9 and the substrate 8, however, the reduction of the heat resistance is not limited to this.

For example, as shown in FIG. 1, it is also possible to reduce the heat resistance by making the contact area large by providing the attaching portion 19a1, 19b1, and 19c1, by making the attaching portion 19a1, 19b1, and 19c1 and the main body unit 2 coming into close contact with each other by screwing, or by providing metal with low heat resistance between the attaching portion 19a1, 19b1, and 19c1 and the main body unit 2.

Subsequently, a case will be exemplified in which a diffusion unit is provided on the surface of the heat conducting unit 9.

The diffusion unit is provided so as to diffuse light which is input to the heat conducting unit.

The diffusion unit may be set to at least any one of a protrusion portion which is provided on the surface of the heat conducting unit, and a diffusion layer 70 (refer to FIG. 1) including a dispersing agent, which is provided on the surface of the heat conducting unit, for example.

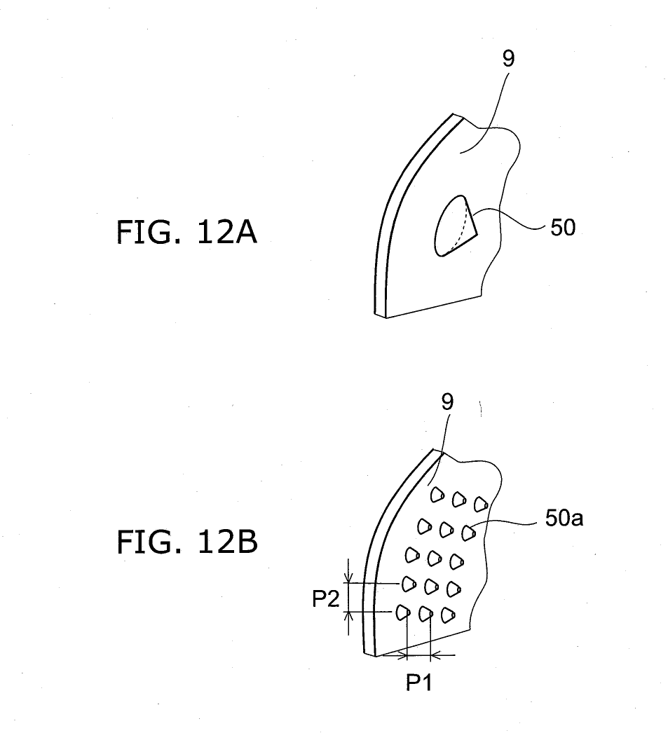

FIGS. 12A and 12B are schematic diagrams which exemplify a protrusion portion which is provided on the surface of the heat conducting unit 9.

In addition, FIG. 12A is a case where one protrusion portion is provided on the surface of the heat conducting unit 9, and FIG. 12B is a case where a plurality of protrusions is provided on the surface of the heat conducting unit 9.

When the protrusion portion is provided on the surface of the heat conducting unit 9, it is possible to diffuse light which is input to the heat conducting unit 9. If it is possible to diffuse the light input to the heat conducting unit 9, it is possible to expand the light distribution angle.

In this case, as shown in FIG. 12A, it is possible to provide one protrusion portion 50 on the surface of the heat conducting unit 9, and to provide a plurality of protrusion portions 50a on the surface of the heat conducting unit 9, as shown in FIG. 12B.

When the plurality of protrusion portions 50a is provided on the surface of the heat conducting unit 9, it is possible to adopt a regular arrangement form, or an arbitrary arrangement form.

In addition, when the plurality of protrusion portions 50a is provided on the surface of the heat conducting unit 9, it is preferable to make pitches P1 and P2 of the protrusion portion 50a be 10 times or more of a wavelength of light irradiated from the light source 3 in order to prevent interference fringes from occurring.

In addition, the shape of the protrusion portion is not limited to the examples, and can be appropriately changed.

As described above, it is a case where the light input to the heat conducting unit 9 is caused to be diffused by providing the protrusion portion on the surface of the heat conducting unit 9, however, it is also possible to make the light input to the heat conducting unit 9 be diffused by providing the diffusion layer 70 on the surface of the heat conducting unit 9.

It is possible to adopt a resin layer including the dispersing agent which diffuses light or the like, as the diffusion layer 70. As the dispersing agent, there are fine particles which are formed of metallic oxide such as silicon oxide, or titanium oxide, or fine particle polymer.

It is possible to diffuse light input to the heat conducting unit 9 by providing the diffusion layer 70 on the surface of the heat conducting unit 9. If it is possible to diffuse light input to the heat conducting unit 9, the light distribution angle can be expanded.

In addition, in FIGS. 12A and 12B, only one surface side of the heat conducting unit 9 is shown, however, it is also possible to provide the protrusion portion, or the diffusion layer on the other surface of the heat conducting unit 9.

Subsequently, an arrangement of the heat conducting unit 9 and the light emitting element 3b when viewed from the upper part of the lighting device 1, that is, the arrangement of the heatconducting unit 9 and the light emitting element 3b when viewed in a planar manner will be exemplified.

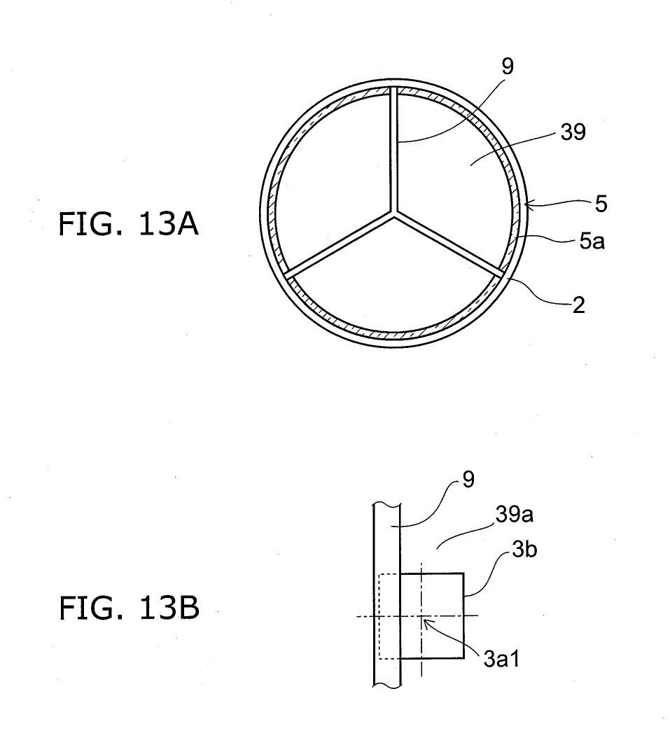

FIGS. 13A and 13B are schematic views which exemplify the arrangement of the heat conducting unit 9 and the light emitting element 3b when viewed in a planar manner.

In addition, FIG. 13A is a schematic view which exemplifies the arrangement of the heat conducting unit 9 and the light emitting element 3b when viewed in a planar manner, and FIG. 13B is a schematic view which exemplifies a positional relationship between the heat conducting unit 9 and the light emitting element 3b when viewed in a planar manner.

As shown in FIG. 13A, a region 39 which is divided by the heat conducting unit 9, when viewed in a planar manner, is formed when the heat conducting unit 9 is provided.

In a case where the plurality of light emitting elements 3b is provided, it is preferable to make the number of light emitting elements 3b provided in each region 39 be the same as each other, in order to suppress light distribution unevenness, or the luminance unevenness. In this case, it is preferable to make the heat conducting unit 9 and the light emitting element 3b not to overlap with each other when viewed in a planar manner.

However, according to the knowledge the inventors got, even when there are light emitting elements 3b a part thereof is overlapped with the heat conducting unit 9 when viewed in a planar manner, it is possible to suppress the light distribution unevenness, or the luminance unevenness, if the center 3a1 of the light emitting element 3b is not overlapped with the heat conducting unit 9.

In this case, it is preferable to make the number of light emitting elements 3b whose center 3a1 is positioned at each region 39 which is divided by the heat conducting unit 9 when viewed in a planar manner be the same as each other in each region 39.

For example, in FIG. 13B, the light emitting element 3b is a light emitting element which is provided at the region 39a.

In addition, it is preferable that the heat conducting unit 9 has a form which is rotation symmetry with respect to the optical axis, or the central axis of the lighting device 1, however, when the number of light emitting elements 3b whose center 3a1 is positioned at each region 39 which is divided by the heat conducting unit 9 when viewed in a planar manner is the same as each other in each region 39, the heat conducting unit may not have the form of rotation symmetry.

In addition, the position at which the light emitting element 3b is provided is not particularly limited. For example, it is also possible to provide the light emitting element 3b at the center of the end portion 2a of the main body unit 2, at the peripheral edge of the end portion 2a of the main body unit 2, or in the entire region of the end portion 2a of the main body unit 2.

Subsequently, the globe 5 will be further exemplified. As shown in FIG. 1, the globe 5 is divided in a portion where the end surface 9e of the heat conducting unit 9 is exposed on the outside of the globe 5.

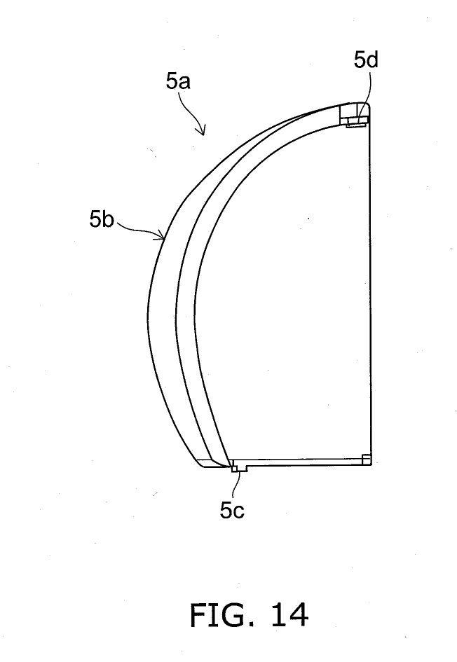

FIG. 14 is a schematic perspective view which exemplifies the globes 5a which are divided into each region which is divided by the heat conducting unit 9.

As shown in FIG. 14, a protrusion portion 5c (corresponding to an example of a first protrusion) is provided at the end surface of the divided globes 5a on the main body unit 2 side. The protrusion portion 5c is provided at a position corresponding to the concave portion 2a1 (corresponding to an example of a first concave portion) (refer to FIG. 1) which is provided at the peripheral edge of the end portion 2a of the main body unit 2. In addition, a protrusion portion 5d (corresponding to an example of a second protrusion portion) is provided on the side facing the side on which the protrusion portion 5c of the divided globes 5a is provided. The protrusion portion 5d is provided at a position corresponding to a concave portion 9k (corresponding to an example of a second concave portion) (refer to FIG. 1) which is provided at the apex portion (in the vicinity of the connection portion of the plate-shaped bodies 19a, 19b, and 19c) of the heat conducting unit 9. When assembling the divided globes 5a, the protrusion portion 5c is fitted into the concave portion 2a1 which is provided at the peripheral edge of the end portion 2a of the main body unit 2, and the protrusion portion 5d is fitted into the concave portion 9k which is provided at the apex portion of the heat conducting unit 9. In this manner, it is possible to easily perform positioning or fixing when assembling the divided globes 5a. In addition, when assembling the divided globes 5a, it is also possible to perform the fixing using an adhesive or the like.

Subsequently, shielding in the apex portion of the heat conducting unit 9 will be exemplified.

As described above, the heat conducting unit 9 is configured by connecting the plurality of plate-shaped bodies to be crossed. For this reason, there is a case where a gap occurs at the apex portion of the heat conducting unit 9 where the connection unit is provided. There is a concern that the light radiated from the light source 3 may be leaked from the gap, or the dust and ash in the outside may come into the globe 5 through the gap, when such a gap occurs.

For this reason, a shielding unit 49 is provided at the apex portion of the heat conducting unit 9.

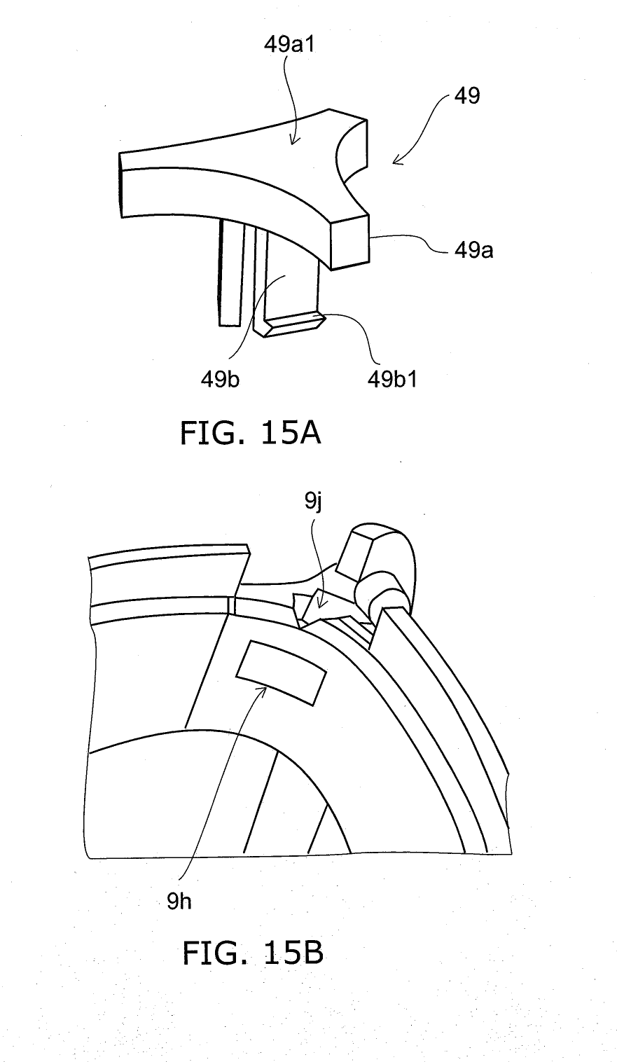

FIGS. 15A and 15B are a schematic perspective views which exemplify the shielding unit 49.

In addition, FIG. 15A is a schematic perspective view which exemplifies the shielding unit 49, and FIG. 15B is a schematic perspective view which exemplifies the apex portion of the heat conducting unit 9.

As shown in FIG. 15A, the shielding unit 49 is provided with a shielding body 49a, and a connection unit 49b.

The shielding body 49a covers a predetermined region in the apex portion of the heat conducting unit 9. The shielding body 49a has a plate shape, and has an external shape corresponding to the shape of the heat conducting unit 9 in the apex portion. In addition, the shielding body 49a has a shape in the thickness direction so that the outer surface 49a1 of the shielding body 49a and the outer peripheral surface 5a of the globe 5 are smoothly connected when assembling the shielding body 49a to the heat conducting unit 9.

The connection unit 49b is provided so as to protrude from the shielding body 49a. A jaw portion 49b1 is provided at the end portion of the connection unit 49b. The jaw portion 49b1 is provided at a position corresponding to a hole 9h which is provided at the heat conducting unit 9. In addition, the connection unit 49b is formed of an elastic material such as resin, and is able to bend.

When assembling the shielding unit 49 to the heat conducting unit 9, the connection unit 49b is fitted into a hold 9j which is provided at the apex portion of the heat conducting unit 9 by being inserted, and the shielding unit 49 is fixed to the heat conducting unit 9 when the jaw portion 49b1 is fitted into the hole 9h.

When the shielding unit 49 is provided at the apex portion of the heat conducting unit 9 at which the connection unit is provided, it is possible to prevent the globe 5 from slipping, or to press the globe 5. For this reason, it is possible to prevent the light radiated from the light source 3 from leaking from the gap, prevent the dust and ash in the outside from coming into the globe 5 from the gap.

Subsequently, an operation and effect of the heat conducting unit 9 will be exemplified.

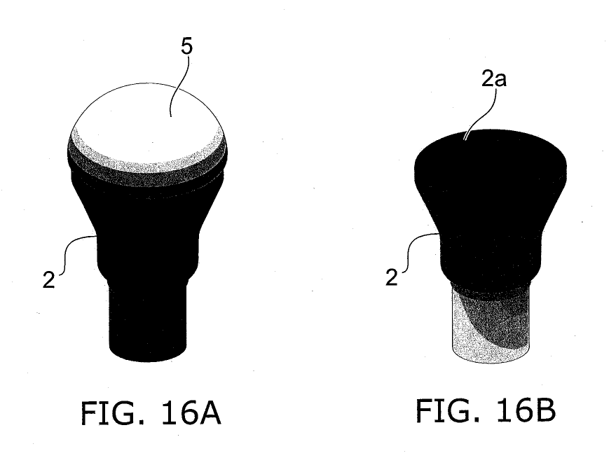

FIGS. 16A and 16B are schematic diagrams which exemplify the state of heat radiation in the lighting device at which the heat conducting unit 9 is not provided.

In addition, FIG. 16A is a schematic diagram which exemplifies temperature distribution of the lighting device, and FIG. 16B is a schematic diagram which exemplifies the temperature distribution in the vicinity of the end portion 2a of the main body unit 2.

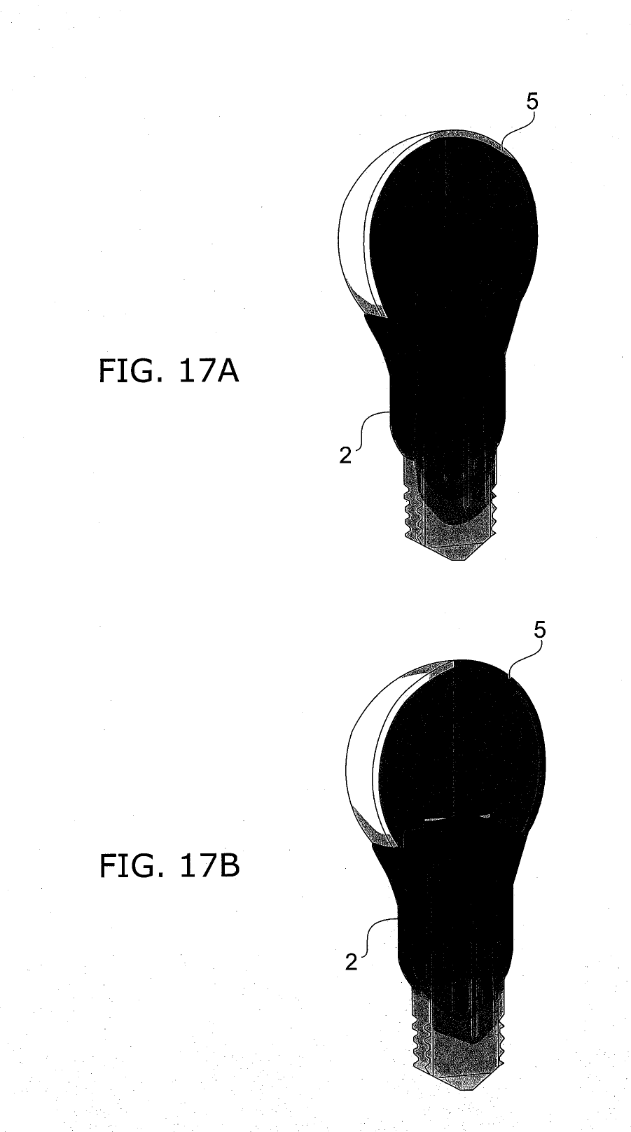

FIGS. 17A and 17B are schematic diagrams which exemplify the state of the heat radiation in the lighting device at which the heat conducting unit 9 is provided.

In addition, FIG. 17A is a case where the inner surface of the globe 5 and the end surface of the heat conducting unit come into contact with each other (a case where the end surface of the heat conducting unit is not exposed on the outside of the globe 5), and FIG. 17B is a case where the end surface of the heat conducting unit 9 is exposed on the outside of the globe 5.

In addition, FIGS. 16A, 16B, 17A, and 17B show a case where the temperature distribution of the lighting device is obtained using a simulation, and an output of the light source 3 is set to approximately 5 W(Watt), and an environmental temperature is set to approximately 25° C.

In addition, the temperature distribution is expressed using monotone-colored light and shade, and is expressed such that the higher the temperature, the darker the color, and the lower the temperature, the brighter the color.

When the heat conducting unit 9 is not provided, as shown in FIG. 16A, the surface temperature of the globe 5 is decreased, however the temperature in the main body unit 2 is increased.

In this case, as shown in FIG. 16B, the temperature in the vicinity of the end portion 2a of the main body unit 2 is increased.

That is, when the heat conducting unit 9 is not provided, heat generated in the light source 3 is radiated from the main body unit 2, and it is understood that the heat radiation from the globe 5 is small. In addition, as shown in FIG. 16B, it is also understood that it is difficult to obtain a sufficient cooling effect only by the heat radiation from the main body unit 2.

In contrast to this, when the heat conducting unit 9 is provided, the heat generated in the light source 3 is able to be transmitted to the globe 5 by the heat conducting unit 9. For this reason, as shown in FIGS. 17A and 17B, it is possible to reduce the temperature in the main body unit 2 by the heat generation from the globe 5.

In addition, when the end surface of the heat conducting unit 9 is exposed on the outside of the globe 5, as shown in FIG. 17B, it is possible to further reduce the temperature in the main body unit 2.

Decrease in temperature in the main body unit 2 means that it is possible to suppress the temperature rise in the light emitting element 3b.

According to the embodiment, since it is possible to radiate heat from the globe 5, as well, through the heat conducting unit 9, it is possible to improve the heat radiation property of the lighting device 1. For this reason, it is possible to make a long life of the lighting device 1. In addition, it is possible to improve the basic performance of the lighting device 1 such as higher luminous flux, expansion of light distribution angle, or the like.

### Second Embodiment

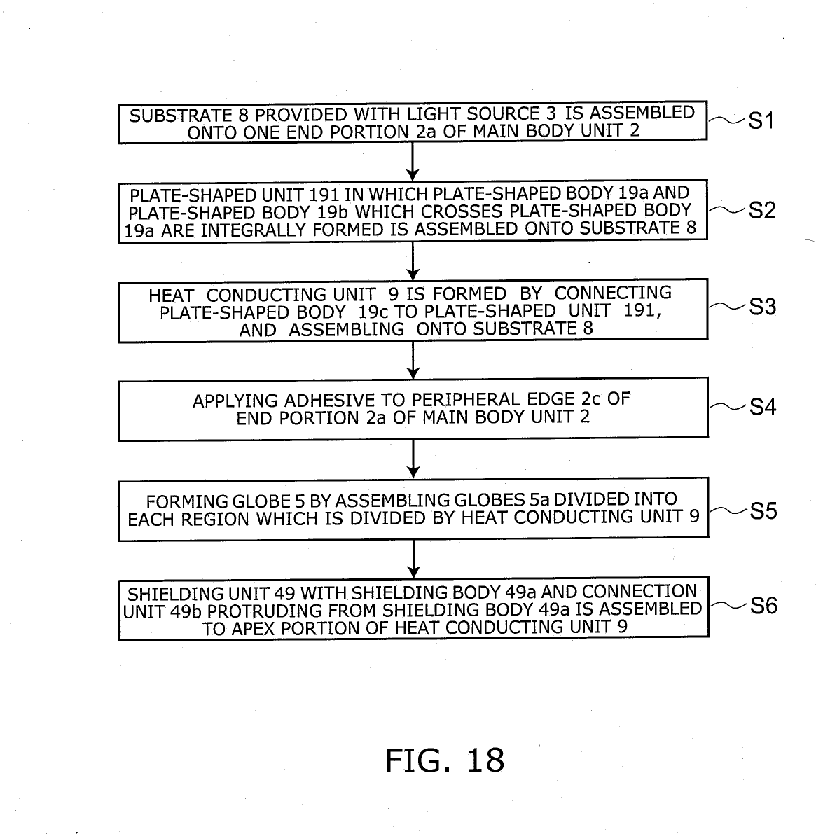

Subsequently, a manufacturing method of a lighting device according to a second embodiment will be exemplified. FIG. 18 is a flowchart which exemplifies a manufacturing method of a lighting device 1 according to the second embodiment.

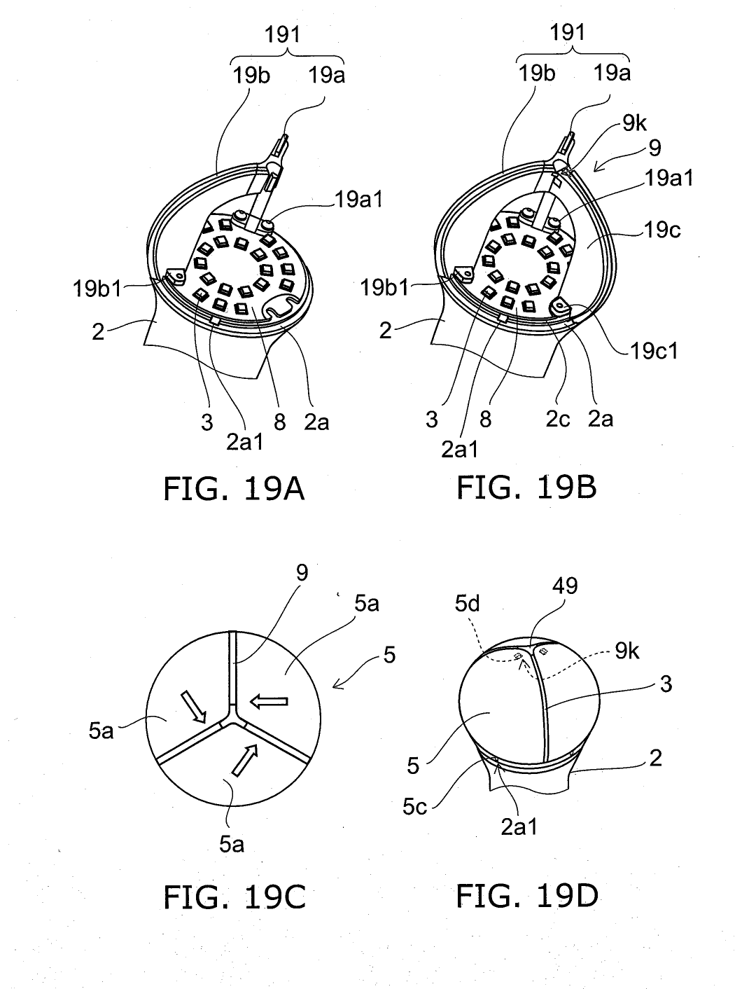

FIGS. 19A to 19D are process drawings which exemplify the manufacturing method of the lighting device 1 according to the second embodiment.

In the manufacturing method of the lighting device 1, there are mainly the assembling in the main body unit 2 (for example, assembling of control unit or the like such as the base unit 6, the lighting circuit, or the like, or the wiring or the like), and the assembling on the end portion 2a of the main body unit 2. In this case, since it is possible to apply a well-known technology when performing the assembling in the main body unit 2, the example will be omitted. Here, the assembling on the end portion 2a of the main body unit 2 will be exemplified.

First, the substrate 8 at which the light source 3 is provided is assembled on the one end portion 2a of the main body unit 2 (step S1).

At this time, the control unit such as the lighting circuit or the like which is provided in the main body unit 2, and the light source 3 are electrically connected. For example, the control unit such as the lighting circuit, and the substrate 8 to which the light source 3 is mounted are connected using wiring.

Subsequently, as shown in FIG. 19A, the plate-shaped unit 191 in which the plate-shaped body 19a, and the plate-shaped body 19b which crosses the plate-shaped body 19a are integrally formed is assembled on the substrate 8 (step S2). At this time, it is possible to fix the plate-shaped unit 191 to the main body unit 2 by screwing the attaching units 19a1 and 19b1.

Subsequently, as shown in FIG. 19B, the plate-shaped body 19c is connected to the plate-shaped unit 191, and is assembled onto the substrate 8, thereby forming the heat conducting unit 9 (step S3).

At this time, the plate-shaped body 19c is assembled from above by fitting the protrusion portion 19e which is provided at the plate-shaped body 19c1 into the groove portion 19d which is provided at the plate-shaped unit 191. In addition, it is also possible to assemble the plate-shaped body 19c from above by fitting the groove portion 19e which is provided at the plate-shaped body 191 into the protrusion portion which is provided at the plate-shaped unit 191. In addition, the plate-shaped body 19c1 is fixed to the main body unit 2 by screwing the attaching portion 19b1 which is provided at the plate-shaped body 19c1. The heat conducting unit 9 is formed on the substrate 8 by assembling the plate-shaped body 19c1 to the plate-shaped unit 191.

Subsequently, as shown in FIG. 19B, a peripheral edge 2c of the end portion 2a of the main body unit 2 is applied with the adhesive (step S4).

Subsequently, as shown in FIG. 19C, the globe 5 is configured by assembling the globes 5a which are divided into each region by the heat conducting unit 9 (step S5).

At this time, a protrusion portion 5c which is provided at the end surface of the globe 5a on the main body unit 2 side is fitted into the concave portion 2a1 which is provided at the peripheral edge of the end portion 2a of the main body unit 2, and the protrusion portion 5d is fitted into the concave portion 9k which is provided at the apex portion of the heat conducting unit 9 (refer to FIG. 19C).

In addition, as shown in the arrows in FIG. 19C, the globe 5a is assembled in a direction which is perpendicular to one surface of the plate-shaped body of the heat conducting unit 9.

The globe 5 is configured by assembling the globes 5a divided into each region which is divided by the heat conducting unit 9.

Subsequently, as shown in FIG. 19D, the shielding unit 49 which includes the shielding body 49a and the connection unit 49b which is protruding from the shielding body 49a is assembled to the apex portion of the heat conducting unit 9 (step S6).

At this time, the connection unit 49b is inserted to the hole 9j which is provided at the apex portion of the heat conducting unit 9, and the shielding unit 49 is fixed to the heat conducting unit 9 by fitting the jaw portion 49b1 into the hole 9h. That is, the connection unit 49b is fitted into the hole 9j which is provided at the apex portion of the heat conducting unit 9, and a predetermined region at the apex of the heat conducting unit 9 is covered by the shielding body 49a. In addition, it is possible to apply the adhesive when the shielding unit 49 is assembled to the heat conducting unit 9 as necessary.

As described above, it is possible to manufacture the lighting device 1.

In addition, since the details of each element configuring the lighting device 1 can be made the same as the above descriptions, detailed descriptions thereof will be omitted.

According to the embodiments which are exemplified as above, it is possible to execute a lighting device which can improve the heat radiation property and a manufacturing method thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A lighting device comprising:
a main body unit;
a light source which is provided at one end portion of the main body unit, and includes a light emitting element;
a globe which is provided so as to cover the light source; and
a heat conducting unit whose end surface on the globe side is exposed on an outside of the globe, and which thermally bonds the globe and a heat radiating surface on the end portion side of the main body unit,
wherein the heat conducting unit includes a plate-shaped unit in which a first plate-shaped body, and a second plate-shaped body which crosses the first plate-shaped body are integrally formed.

2. The device according to claim 1,
wherein the heat conducting unit further includes a fifth plate-shaped body,
wherein the plate-shaped unit includes a third groove portion, or a third protrusion portion at a portion at which the plate-shaped unit is connected to the fifth plate-shaped body, and
wherein the fifth plate-shaped body includes a fourth protrusion portion which is fitted into the third groove portion, or a fourth groove portion which is fitted into the third protrusion portion.

3. The device according to claim 1, further comprising:
a substrate which is provided at the end portion of the main body unit,
wherein the light source, and the heat conducting unit are provided on the substrate.

4. The device according to claim 1, further comprising:
a shielding unit which is provided at an apex portion of the heat conducting unit,
wherein the shielding unit includes a shielding body which covers a predetermined region at the apex portion of the heat conducting unit, and a connection unit which protrudes from the shielding body, and which is fitted into a hole which is provided at the apex portion of the heat conducting unit.

5. The device according to claim 1,
wherein the globe is divided at a portion in which the end surface of the heat conducting unit is exposed on the outside of the globe, and
wherein an end surface of the divided globe on the main body unit side is provided with a first protrusion portion which is fitted into a first concave portion provided at a peripheral edge of the end portion of the main body unit, and a second protrusion portion which is fitted into a second concave portion which is provided at an apex portion of the heat conducting unit, is provided at a side facing the side on which the first protrusion portion of the divided globes is provided.

6. The device according to claim 1,
wherein the first plate-shaped body, and the second plate-shaped body respectively include opening portions which penetrate in a thickness direction, respectively.

7. A lighting device comprising:
a main body unit;
a light source which is provided at one end portion of the main body unit, and includes a light emitting element;
a globe which is provided so as to cover the light source; and
a heat conducting unit whose end surface on the globe side is exposed on the outside of the globe, and which thermally bonds the globe and a heat radiating surface on the end portion side of the main body unit,
wherein the heat conducting unit includes a third plate-shaped body, and a fourth plate-shaped body which is connected to the third plate-shaped body,
wherein the third plate-shaped body includes a first groove portion, or a first protrusion portion at a portion connected with the fourth plate-shaped body, and
wherein the fourth plate-shaped body includes a second protrusion portion which is fitted into the first groove portion, or a second groove portion which is fitted into the first protrusion portion.

8. The device according to claim 7, further comprising:
a substrate which is provided at the end portion of the main body unit,
wherein the light source, and the heat conducting unit are provided on the substrate.

9. The device according to claim 7, further comprising:
a shielding unit which is provided at an apex portion of the heat conducting unit,
wherein the shielding unit includes a shielding body which covers a predetermined region at the apex portion of the heat conducting unit, and a connection unit which protrudes from the shielding body, and which is fitted into a hole which is provided at the apex portion of the heat conducting unit.

10. The device according to claim 7,
wherein the globe is divided at a portion in which the end surface of the heat conducting unit is exposed on the outside of the globe, and
wherein the end surface of the divided globe on the main body unit side is provided with a first protrusion portion which is fitted into a first concave portion which is provided at a peripheral edge of the end portion of the main body unit, and a second protrusion portion which is fitted into a second concave portion which is provided at the apex portion of the heat conducting unit is provided at a side facing the side on which the first protrusion portion of the divided globes is provided.

11. The device according to claim 7,
wherein the third plate-shaped body, and the fourth plate-shaped body respectively include opening portions which respectively penetrate in a thickness direction.

12. A manufacturing method of a lighting device comprising:
assembling a substrate to which a light source is provided onto one end portion of a main body unit;
assembling a plate-shaped unit in which a first plate-shaped body, and a second plate-shaped body which intersects the first plate-shaped body are integrally formed onto the substrate;
forming a heat conducting unit by connecting a fifth plate-shaped body to the plate-shaped unit, and by assembling the fifth plate-shaped body onto the substrate; and
forming a globe by assembling the globe divided into each region which is divided by the heat conducting unit.

13. The method according to claim 12,
wherein, in the forming of the heat conducting unit,
a fourth protrusion portion which is fitted into a third groove portion which is provided at the fifth plate-shaped body, or a fourth groove portion which is fitted into a third protrusion portion is fitted into the third groove portion, or the third protrusion portion provided at a portion connected to the fifth plate-shaped body of the plate-shaped unit from above.

14. The method according to claim 12, further comprising:
assembling a shielding unit which includes a shielding body, and a connection unit which protrudes from the shielding unit to an apex portion of the heat conducting unit,
wherein in the assembling of the shielding unit, the connection unit is fitted into a hole which is provided at the apex portion of the heat conducting unit, and a predetermined region in the apex portion of the heat conducting unit is covered by the shielding body.

15. The method according to claim 12,
wherein, in the forming of the globe, a first protrusion portion which is provided at the end surface of the main body unit of the divided globes is fitted into a first concave portion which is provided at a peripheral edge of the end portion of the main body unit, and a second protrusion portion which is provided at a side facing the side on which the first protrusion portion of the divided globes is provided is fitted into a second concave portion which is provided at the apex portion of the heat conducting unit.

16. A lighting device comprising:
a main body unit;
a substrate provided at one end of the main body unit, and includes a light emitting element;
a globe covering the light emitting element;
a heat conducting unit having better thermal conductivity than the globe and thermally bonded to the substrate, the heat conducting unit including a plurality of curved structures each configured to provide a sealed enclosure for the light emitting element together with the globe, each of the curved structures having an exterior surface extending from an outer periphery of the substrate to an apex of the globe; and
a shielding unit exposed to the exterior at the apex of the globe and covering connecting portions of the curved structures.

17. The device according to claim 16, wherein the curved structures include first and second curved structures, and the connecting portions include a groove formed on the first curved structure and a projection that is fitted into the groove and formed on the second curved structure.

18. The device according to claim 16, wherein the curved structures include first, second, and third curved structures, and the connecting portions include grooves formed on the first and second curved structures and a projection that is fitted into the grooves and formed on the third curved structure.

19. The device according to claim 16, wherein each of the curved structures are thermally bonded to the main body unit.

20. The device according to claim 19, wherein each of the curved structures includes a step portion at portions contacting the globe.
